(19) United States
(12) Patent Application Publication
(10) Pub. No.: US 2014/0219786 A1
(43) Pub. Date: Aug. 7, 2014

(54) VOLUTE DEVICE FOR TURBINE

(71) Applicants: Zhifu ZHU, Shouguang (CN); Ying LIU, Shouguang (CN); Daojun YUAN, Shouguang (CN); Yanxia WANG, Shouguang (CN); Jinming ZHANG, Shouguang (CN); Guoqiang YANG, Shouguang (CN); Mingliang GUO, Shouguang (CN); Wenjuan ZHENG, Shouguang (CN)

(72) Inventors: Zhifu ZHU, Shouguang (CN); Ying LIU, Shouguang (CN); Daojun YUAN, Shouguang (CN); Yanxia WANG, Shouguang (CN); Jinming ZHANG, Shouguang (CN); Guoqiang YANG, Shouguang (CN); Mingliang GUO, Shouguang (CN); Wenjuan ZHENG, Shouguang (CN)

(21) Appl. No.: 14/247,266

(22) Filed: Apr. 8, 2014

Related U.S. Application Data
(63) Continuation-in-part of application No. PCT/CN2012/000181, filed on Feb. 15, 2012.

(30) Foreign Application Priority Data
Oct. 8, 2011 (CN) 201110297550.0

(51) Int. Cl. F02B 37/22

(52) U.S. Cl. CPC F02B 37/225
USPC 415/151; 415/182.1

(57) ABSTRACT

A volute device, including: an intake passage including an inner passage and an outer passage; a gas inlet including a first gas inlet and a second gas inlet; and a gas outlet. The gas inlet is disposed at one end of the intake passage, and the gas outlet is disposed at the other end of the intake passage. A first inner passage and a first outer passage communicate with the first gas inlet to suck gas in a semicircle of a circumference direction at between 0° and 180°. A second inner passage and a second outer passage communicate with the second gas inlet to suck gas in another semicircle of the circumference direction at between 180° and 360°.

### CROSS-REFERENCE TO RELATED APPLICATIONS

This application is a continuation-in-part of International Patent Application No. PCT/CN2012/000181 with an international filing date of Feb. 15, 2012, designating the United States, now pending, and further claims priority benefits to Chinese Patent Application No. 201110297550.0 filed Oct. 8, 2011. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to the field of the internal combustion engine, and more particularly to a volute device for a variable-geometry pulse turbine.

2. Description of the Related Art

A typical volute for a double-cavity semi-circular intake turbine includes an upper passage and a lower passage. The upper passage has a gas intake range of between 0° and 180°, the lower passage has a gas intake range of between 180° and 360°. The gas intake ranges of the upper passage and the lower passage form a total circular intake range of 360°. The intake gas flow is introduced into the upper passage and the lower passage, respectively, to drive the turbine impeller to do work. The turbocharger is required to possess much higher boost pressure and adjustable exhaust pressure to meet the increasingly stringent emissions requirements. However, as the cross sectional area of the turbine is constant, the requirements cannot be satisfied.

To solve the problem of the constant cross sectional area of the turbine, a rotatable nozzle vane is mounted at a nozzle on the volute to form a rotary vane variable-geometry turbine. The cross sectional area of the intake flow of the turbine is changed by regulating the opening degree of rotation of the nozzle vane, so that the control is convenient. However, when the engine is in a large flow working condition, the opening degree of the nozzle vane increases, and the nozzle vane is relatively close to a front edge of the turbine impeller, so that the regulation range for increasing the opening degree is restricted. When the engine is in a small flow working condition, the opening degree of the nozzle vane is very small, the gas flow at the nozzle outlet has a high circumferential speed, and the turbine becomes an impulse turbine, thereby resulting in relatively large impact damage and poor stability. Besides, a distance between the nozzle outlet and the impeller inlet is relatively long, and the gas flow of the annular zone therein interferences with each other, so that the flow loss is increased, and the efficiency of the turbocharger is decreased.

Furthermore, the rotary vane variable-geometry turbine has a high production cost and short service life.

### SUMMARY OF THE INVENTION

In view of the above-described problems, it is one objective of the invention to provide a volute device for a variable-geometry pulse turbine. The volute has a simple structure, high stability, and high efficiency in low-speed working condition, improves the work capacity of the turbine, satisfies the flow capacities of the engine at both low and high speeds, and prevents the turbocharger from overspeeding.

To achieve the above objective, in accordance with one embodiment of the invention, there is provided a volute device comprising a volute, the volute comprising: an intake passage, the intake passage comprising: an inner passage and an outer passage, the inner passage comprising a first inner passage and a second inner passage, the outer passage comprising a first outer passage and a second outer passage; a gas inlet, the gas inlet comprising: a first gas inlet, and a second gas inlet; and a gas outlet. The gas inlet is disposed at one end of the intake passage, and the gas outlet is disposed at the other end of the intake passage. The first inner passage and the first outer passage communicate with the first gas inlet to suck gas in a semicircle of a circumference direction at between 0° and 180°. The second inner passage and the second outer passage communicate with the second gas inlet to suck gas in another semicircle of the circumference direction at between 180° and 360°.

In a class of this embodiment, intake regulation devices are disposed at the first outer passage close to the first gas inlet and at the second outer passage close to the second gas inlet, respectively.

In a class of this embodiment, the intake regulation devices are disposed at the same side of the volute.

In a class of this embodiment, the intake regulation devices are disposed at two sides of the volute, respectively.

In a class of this embodiment, the intake regulation device comprises a valve shaft disposed inside the volute. Two ends of the valve shaft are in rotatable connection with the volute. One end of the valve shaft extends to an outer part of the volute and is in transmission connection with an actuating mechanism. The valve shaft passes through the first outer passage and the second outer passage. Parts of the valve shaft disposed inside the first outer passage and the second outer passage are provided with valves, respectively.

In a class of this embodiment, a valve cap is disposed at a position of the volute corresponding to the valve; and the valve cap and the volute are in fixed and sealed connection.

The opening and closing of the valve are controlled by the actuating mechanism. The allocation of the intake gas flow is controlled by regulating the opening degree of the valve, thereby achieving the co-working between the inner passage and the outer passage.

In a class of this embodiment, cross sections of the first gas inlet and the second gas inlet are in trapezoid structures and are arranged from top to bottom.

In a class of this embodiment, cross sections of the first gas inlet and the second gas inlet are in rectangular structures and are arranged in parallel from left to right.

In a class of this embodiment, the first outer passage, the first inner passage, the second inner passage, and the second outer passage are arranged in parallel inside the volute.

In a low speed working condition of the engine, the valve is in a closed state, the inner passage is in the work sate, and the intake gas flow discharged from the exhaust pipe only passes through the working passage. As the cross sectional area of the turbine is decreased, the intake pressure of the turbine and the available energy in the exhaust gas are increased, the work capacity of the turbine is enhanced, and the efficiency of the turbine at a low speed is improved, thereby satisfying the low-speed performance of the engine and the purpose of emission reduction.

In a high-speed working condition of the engine, the valve is in an open state. The opening degree of the intake valve is controlled by the actuating mechanism according to the practical working condition of the engine. Both the inner passage and the outer passage are in the work state. In the co-working condition of the passages, the gas flow in the turbine is reasonably allocated, thereby satisfying the requirements on the performance of the engine at the high-speed working condition.

Advantages according to embodiments of the invention are summarized as follows:

The structure of the turbine volute of the invention is basically the same as that of a common turbocharger volute. The volute structure has a simple structure, good succession, and low production costs, and is easy and fast to achieve engineering. The intake regulation device of the invention has a simple structure, flexible controllability, and high reliability.

In summary, the volute device for the variable-geometry pulse turbine satisfies the pressurizing requirements in all working conditions. The turbocharger equipped with the volute device has non-obvious variations in external structures and low production costs. The volute device of the invention has a high market value and is suitable for engineering and industrialization.

### BRIEF DESCRIPTION OF THE DRAWINGS

The invention is described hereinbelow with reference to the accompanying drawings, in which:

FIG. 1 is a structure diagram of a volute device in accordance with Example 1;

FIG. 2 is a cross sectional view of a volute device showing a section between 0° and 180° of an intake passage in accordance with Example 1;

FIG. 3 is a structure diagram of an exhaust manifold in accordance with Example 1;

FIG. 4 is a structure diagram of an intake regulation device in accordance with Example 1;

FIG. 5 is a structure diagram of a valve cap in accordance with Example 1;

FIG. 6 is a structure diagram of a volute device in accordance with Example 2;

FIG. 7 is across sectional view of a volute device showing a section between 0° and 180° of an intake passage in accordance with Example 2;

FIG. 8 is a structure diagram of an exhaust manifold in accordance with Example 2; and

FIG. 9 is a structure diagram of an intake regulation device in accordance with Example 2.

In the drawings, the following reference numbers are used: 1. First gas inlet; 2. Second gas inlet; 3. Volute; 4. Gas outlet; 5. First inner passage; 6. Second inner passage; 7. First outer passage; 8. Second outer passage; 9. Valve; 10. Valve shaft; 11. Shaft sleeve; 12. Actuating mechanism; 13. Valve cap; 14. First exhaust pipe outlet; and 15. Second exhaust pipe outlet.

### DETAILED DESCRIPTION OF THE EMBODIMENTS

For further illustrating the invention, experiments detailing a volute device for a variable-geometry pulse turbine are described below. It should be noted that the following examples are intended to describe and not to limit the invention.

### Example 1

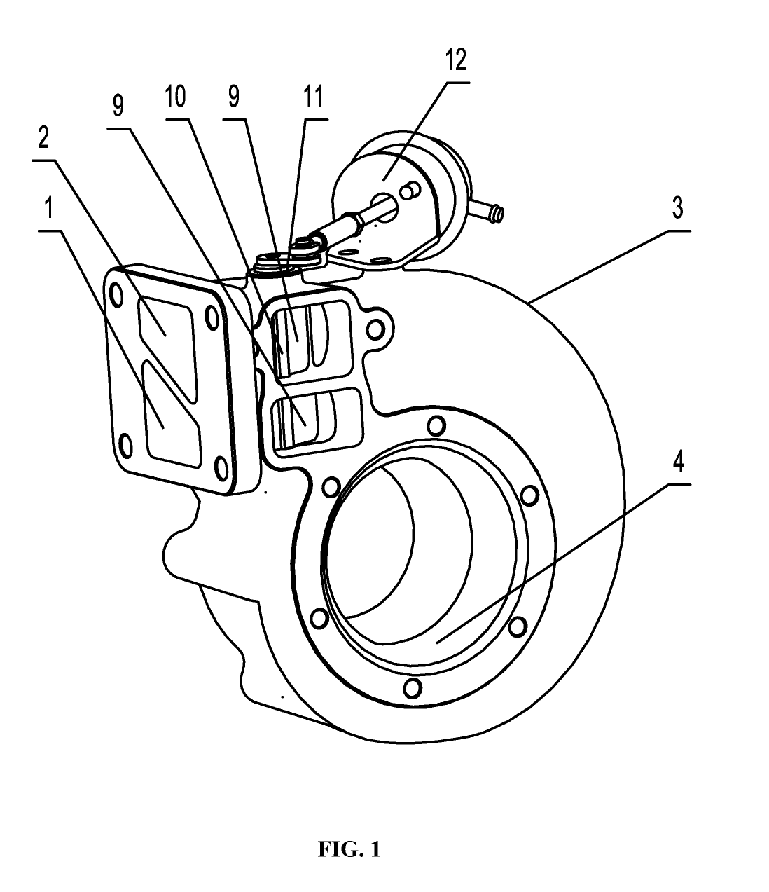

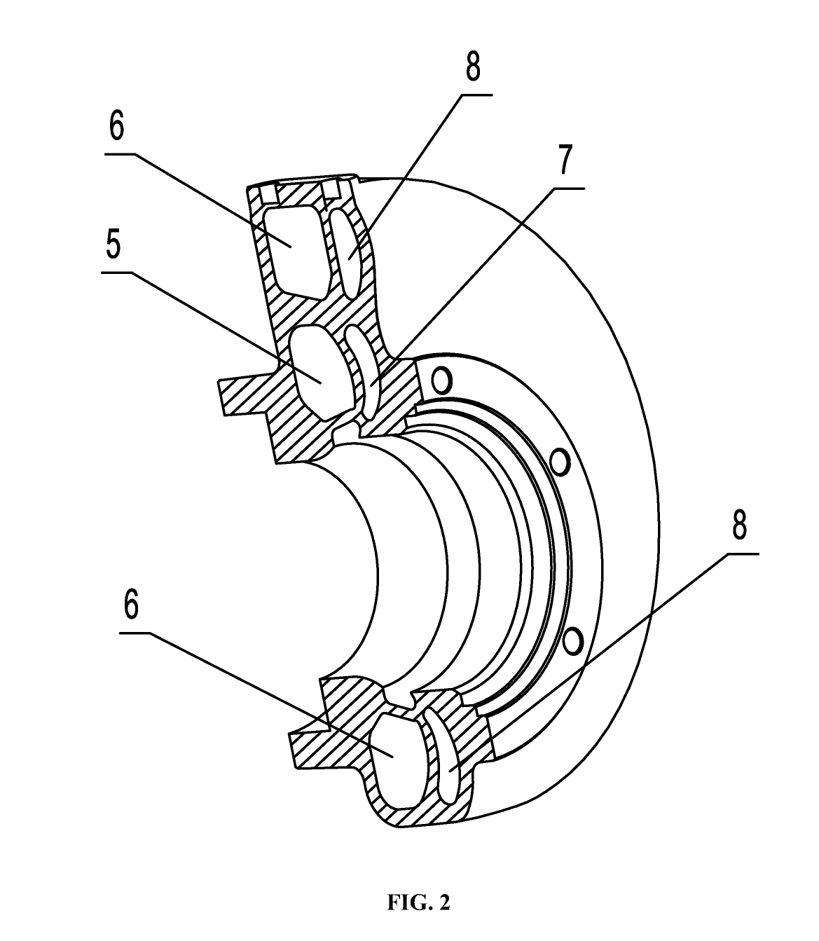

As shown in FIGS. 1-2, a volute device for a variable-geometry pulse turbine comprises a volute 3 comprising an intake passage. On one end of the intake passage disposed is a gas inlet, and on the other end of the intake passage disposed is a gas outlet 4.

The intake passage comprises two groups of working passages, of which, one group is an inner passage, and the other group is an outer passage. The outer passage is disposed at one side of the inner passage.

The inner passage comprises a first inner passage 5 and a second inner passage 6. The outer passage comprises a first outer passage 7 and the second outer passage 8.

The gas inlet comprises a first gas inlet 1 and a second gas inlet 2.

The first inner passage 5 and the first outer passage 7 communicate with the first gas inlet 1 to suck gas in a semicircle of a circumference direction at between 0° and 180°.

The second inner passage 6 and the second outer passage 8 communicate with the second gas inlet 2 to suck gas in another semicircle of the circumference direction at between 180° and 360°.

Intake regulation devices are disposed at the first outer passage 7 close to the first gas inlet 1 and at the second outer passage 8 close to the second gas inlet 2, respectively.

Cross sections of the first gas inlet 1 and the second gas inlet 2 are in trapezoid structures arranged from top to bottom. The first gas inlet 1 and the second gas inlet 2 communicate with an exhaust manifold, respectively.

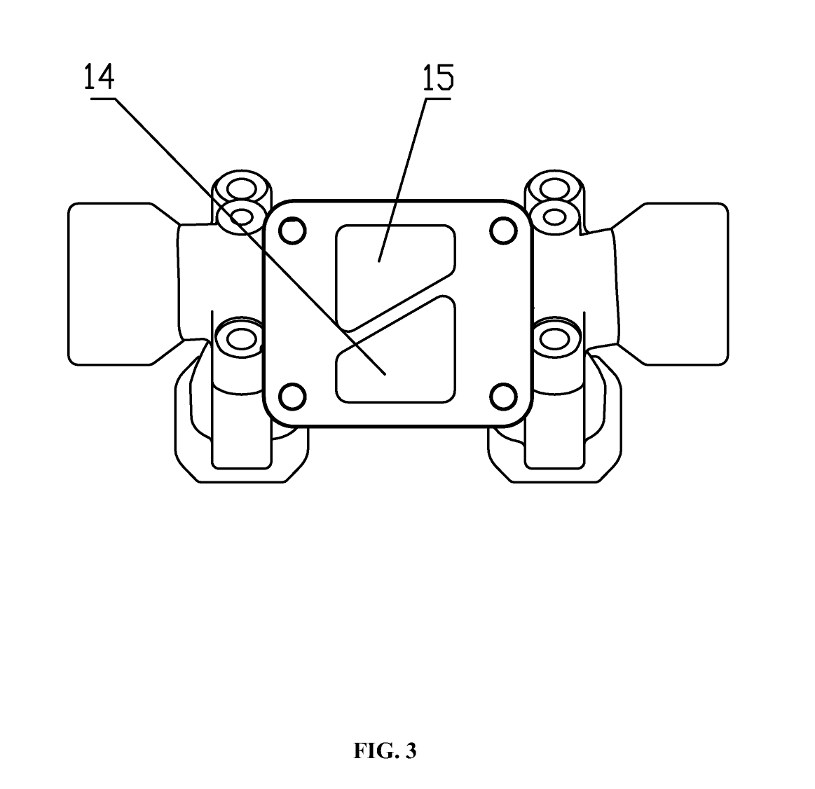

As shown in FIG. 3, the exhaust manifold comprises a first exhaust outlet 14 and a second exhaust outlet 15, both of which have cross sections in the shape of trapezoid. The first inner passage 5 and the first outer passage 7 communicate with the corresponding first exhaust outlet 14 via the first gas inlet 1. The second inner passage 6 and the second outer passage 8 communicate with the corresponding second exhaust outlet 15 via the second gas inlet 2.

The first inner passage 5 and the second inner passage 6 are always in a working condition. The first outer passage 7 and the second outer passage 8 are switched between the working condition and non-working condition controlled by the intake regulation devices. Each group of working passage sucks the gas flow for the turbine impeller within 360°.

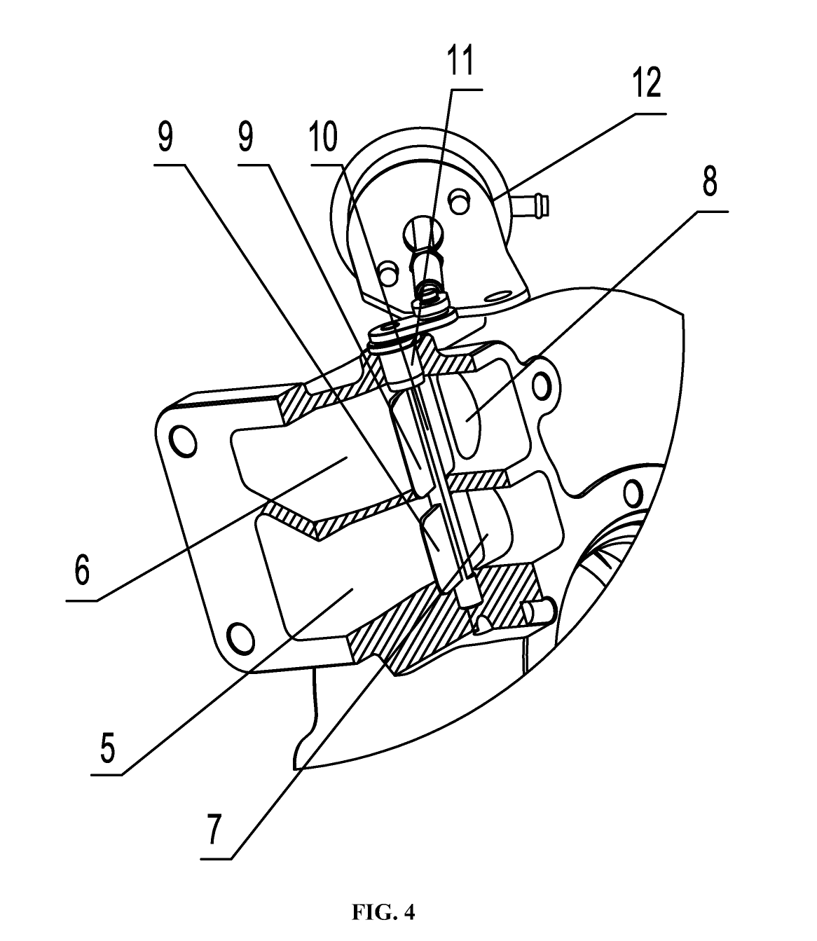

As shown in FIG. 4, the two intake regulation devices of the two outer passages are disposed at the same side of the volute, and the allocation of the intake gas flow is conducted by the intake regulation devices according to the practical working condition of the engine.

The intake regulation device comprises a valve shaft 10 disposed inside the volute 3. Two ends of the valve shaft 10 are in rotatable connection with the volute 3 via a shaft sleeve 11. One end of the valve shaft 10 extends to an outer part of the volute 3 and is in transmission connection with an actuating mechanism 12. The valve shaft 10 passes through the first outer passage 7 and the second outer passage 8. Parts of the valve shaft 10 disposed inside the first outer passage 7 and the second outer passage 8 are provided with valves 9, respectively.

The opening and closing of the valve 9 are controlled by the actuating mechanism 12, and the allocation of the intake gas flow is controlled by regulating the opening degree of the valve 9, thereby achieving co-working between the inner passage and the outer passage.

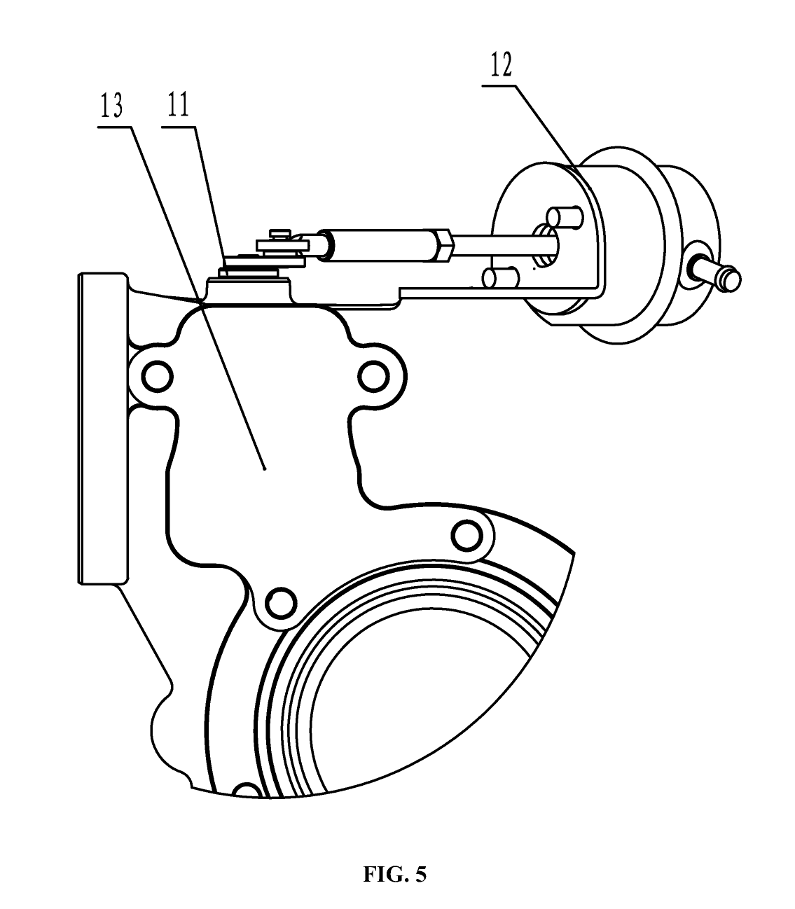

As shown in FIG. 5, a valve cap 13 is disposed at a position of the volute corresponding to the valve 9; and the valve cap 13 and the volute 3 are in fixed and sealed connection.

The valve cap functions in sealing and as a press plate between the volute and a middle casing.

In a low speed working condition of the engine, the valve 9 is in a closed state under the control of the actuating mechanism 12, and the first outer passage 7 and the second outer passage 8 are in a sealed state and do not communicate with the gas inlet. The exhaust gas discharged from the exhaust manifold only passes through the first inner passage 5 and the second inner passage 6 of the working passages. In other words, only the first inner passage 5 and the second inner passage 6 work while the first outer passage 7 and the second outer passage 8 do not work. As the cross sectional area of the turbine is decreased, the intake pressure of the turbine and the available energy in the exhaust gas are increased, the work capacity of the turbine is enhanced, and the efficiency of the turbine at a low speed is improved, thereby satisfying the low-speed performance of the engine and the purpose of emission reduction.

In a high-speed working condition of the engine, the valve 9 is in an open state under the control of the actuating mechanism. The opening degree of the valve 9 is controlled by the actuating mechanism according to the practical working condition. All of the first inner passage 5, the second inner passage 6, the first outer passage 7, and the second outer passage 8 communicate with the gas inlet. In other words, the outer and inner passages of both the groups of working passages work. In the co-working condition of all the passages, the gas flow in the turbine is reasonably allocated, thereby satisfying the requirements on the performance of the engine at the high-speed working condition.

### Example 2

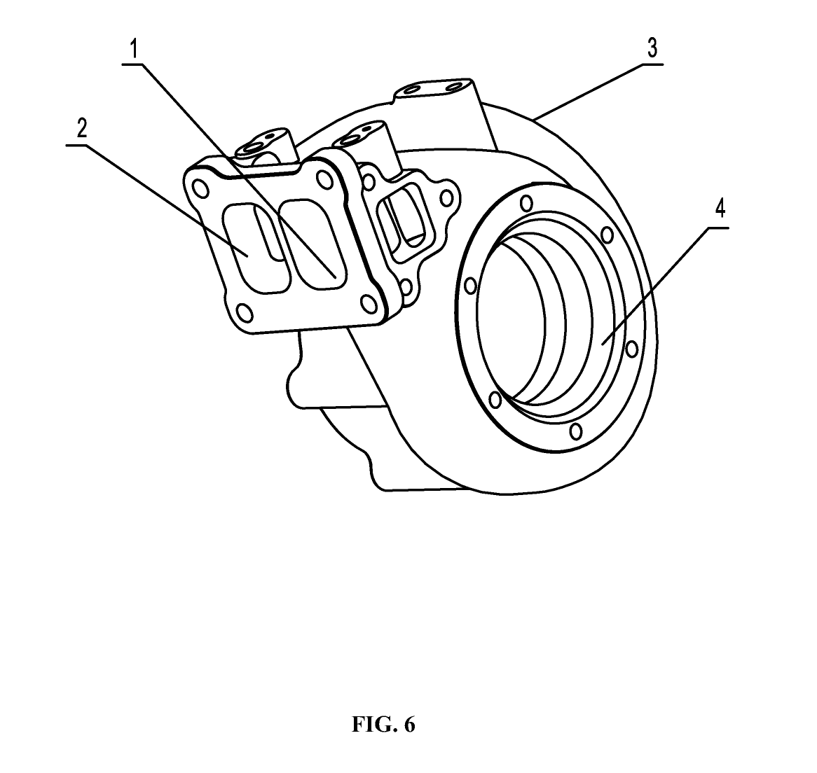

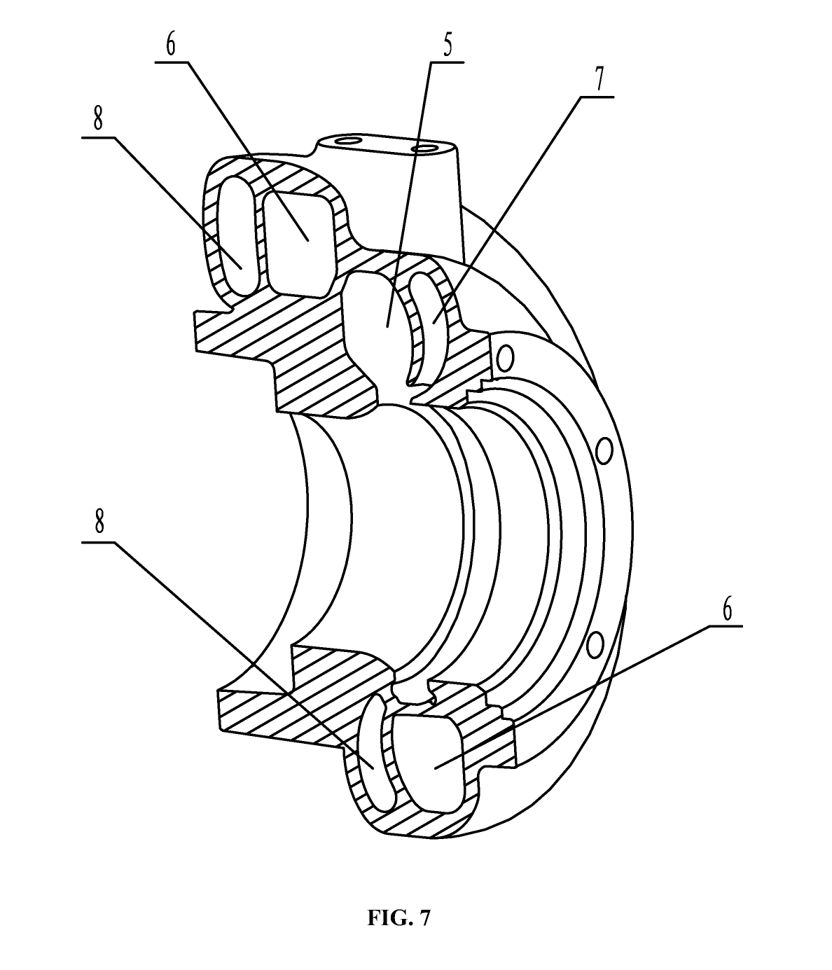

As shown in FIGS. 6-7, cross sections of the first gas inlet 1 and the second gas inlet 2 are in rectangular structures and are arranged in parallel from left to right. The first gas inlet 1 and the second gas inlet 2 communicate with the exhaust manifold, respectively.

The first outer passage 7, the first inner passage 5, the second inner passage 6, and the second outer passage 8 are arranged in parallel in the volute.

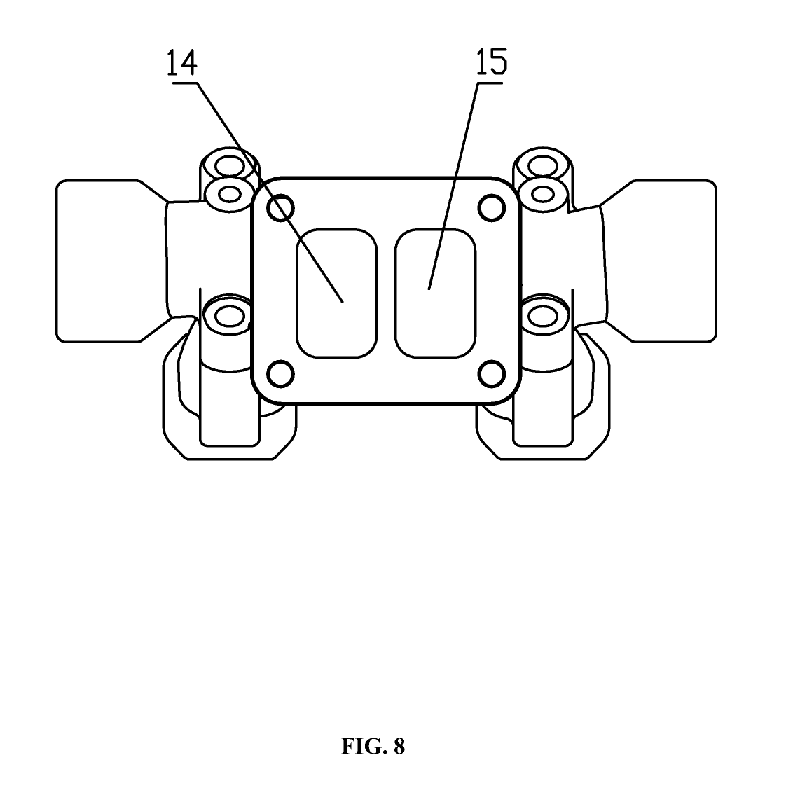

As shown in FIG. 8, the exhaust manifold comprises a first exhaust outlet 14 and a second exhaust outlet 15, both of which have rectangular cross sections. The first inner passage 5 and the first outer passage 7 communicate with the corresponding first exhaust outlet 14 via the first gas inlet 1. The second inner passage 6 and the second outer passage 8 communicate with the corresponding second exhaust outlet 15 via the second gas inlet 2.

### Example 3

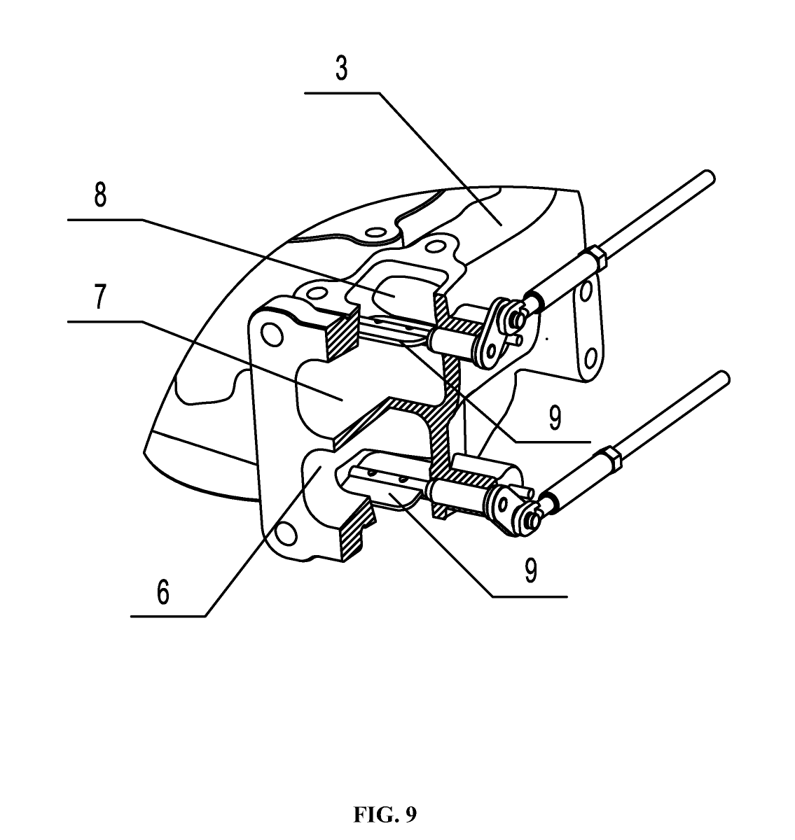

As shown in FIG. 9, the two intake regulation devices of the outer passages are disposed at both sides of the volute. The allocation of the intake gas flow is controlled by the intake regulation device according to the practical working condition of the engine.

The volute device of the invention focuses on the requirement of the engine on the variable cross section turbocharger, effectively utilizes the exhaust energy, and satisfies the pressurization requirements in both low-speed and high-speed working conditions. The volute device can be manufactured according to the casting and processing technology for conventional turbochargers.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A volute device, comprising a volute, the volute comprising:
a) an intake passage, the intake passage comprising: an inner passage and an outer passage, the inner passage comprising a first inner passage and a second inner passage, and the outer passage comprising a first outer passage and a second outer passage;
b) a gas inlet, the gas inlet comprising: a first gas inlet, and a second gas inlet; and
c) a gas outlet;
wherein
the gas inlet is disposed at one end of the intake passage, and the gas outlet is disposed at the other end of the intake passage;
the first inner passage and the first outer passage communicate with the first gas inlet to suck gas in a semicircle of a circumference direction at between 0° and 180°; and
the second inner passage and the second outer passage communicate with the second gas inlet to suck gas in another semicircle of the circumference direction at between 180° and 360°.

2. The volute device of claim 1, wherein intake regulation devices are disposed at the first outer passage close to the first gas inlet and at the second outer passage close to the second gas inlet, respectively.

3. The volute device of claim 2, wherein the intake regulation devices are disposed at the same side of the volute.

4. The volute device of claim 2, wherein the intake regulation devices are disposed at two sides of the volute, respectively.

5. The volute device of claim 3, wherein
the intake regulation devices comprise a valve shaft disposed inside the volute;
two ends of the valve shaft are in rotatable connection with the volute;
one end of the valve shaft extends to an outer part of the volute and is in transmission connection with an actuating mechanism;
the valve shaft passes through the first outer passage and the second outer passage; and
parts of the valve shaft disposed inside the first outer passage and the second outer passage are provided with valves, respectively.

6. The volute device of claim 4, wherein
the intake regulation device comprises a valve shaft disposed inside the volute;
two ends of the valve shaft are in rotatable connection with the volute;
one end of the valve shaft extends to an outer part of the volute and is in transmission connection with an actuating mechanism;
the valve shaft passes through the first outer passage and the second outer passage; and
parts of the valve shaft disposed inside the first outer passage and the second outer passage are provided with valves, respectively.

7. The volute device of claim 5, wherein a valve cap is disposed at a position of the volute corresponding to the valve; and the valve cap and the volute are in fixed and sealed connection.

8. The volute device of claim 6, wherein a valve cap is disposed at a position of the volute corresponding to the valve; and the valve cap and the volute are in fixed and sealed connection.

9. The volute device of claim 7, wherein cross sections of the first gas inlet and the second gas inlet are in trapezoid structures and are arranged from top to bottom.

10. The volute device of claim 8, wherein cross sections of the first gas inlet and the second gas inlet are in trapezoid structures and are arranged from top to bottom.

11. The volute device of claim 7, wherein cross sections of the first gas inlet and the second gas inlet are in rectangular structures and are arranged in parallel from left to right.

12. The volute device of claim 8, wherein cross sections of the first gas inlet and the second gas inlet are in rectangular structures and are arranged in parallel from left to right.

13. The volute device of claim 11, wherein the first outer passage, the first inner passage, the second inner passage, and the second outer passage are arranged in parallel inside the volute.

14. The volute device of claim 12, wherein the first outer passage, the first inner passage, the second inner passage, and the second outer passage are arranged in parallel inside the volute.
